(19) United States
(12) Patent Application Publication
(10) Pub. No.: US 2026/0340538 A1
(43) Pub. Date: Oct. 29, 2026

(54) AGENTIC ORDER PROCESSING WORKFLOW SELECTION

(71) Applicant: DELL PRODUCTS L.P., Round Rock, TX (US)

(72) Inventors: Venugopal Swarna, Bangalore (IN); Sunkara Venkata Krishna, Mulapadu (IN); Shashi Kumar, Bangalore (IN); Shibi Panikkar, Bangalore (IN)

(21) Appl. No.: 19/190,040

(22) Filed: Apr. 25, 2025

(51) Int. Cl. G06Q 10/0631; G06F 40/284; G06F 40/295

(52) U.S. Cl. CPC G06Q 10/06316; G06F 40/284; G06F 40/295

(57) ABSTRACT

An information handling system receives input items associated with a process request, evaluates the input items with a first deterministic model to associate a first portion of the input items with known data entities and to classify a second portion of the input items as unknown input information items, evaluate the second portion of the input items with a first non-deterministic model to associate the second portion of the input items with the known data entities, evaluate the known data entities with a second deterministic model to determine whether a process type of the process request can be identified by the second deterministic model, and when the process type can be identified, identify the process type, when the process type cannot be identified by the second deterministic model, evaluate the known data entities with a second non-deterministic model to identify the process type, select one of a plurality of tasks associated with the process type, and execute the task to fulfill the process request.

### FIELD OF THE DISCLOSURE

This disclosure relates to information handling systems, and more particularly relates to agentic order processing workflow selection in an information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

A n information handling system receives input items associated with a process request, evaluates the input items with a first deterministic model to associate a first portion of the input items with known data entities and to classify a second portion of the input items as unknown input information items, evaluate the second portion of the input items with a first non-deterministic model to associate the second portion of the input items with the known data entities, evaluate the known data entities with a second deterministic model to determine whether a process type of the process request can be identified by the second deterministic model. When the process type can be identified, the information handling system is configured to identify the process type, and when the process type cannot be identified by the second deterministic model, the information handling system is configured to evaluate the known data entities with a second non-deterministic model to identify the process type, select one of a plurality of tasks associated with the process type, and execute the task to fulfill the process request.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating an order processing system according to an embodiment of the present disclosure; and

FIG. 2 is a block diagram illustrating a generalized information handling system according to another embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application.

The teachings can also be used in other applications, and with several different types of architectures, such as distributed computing architectures, client/server architectures, or middleware server architectures and associated resources.

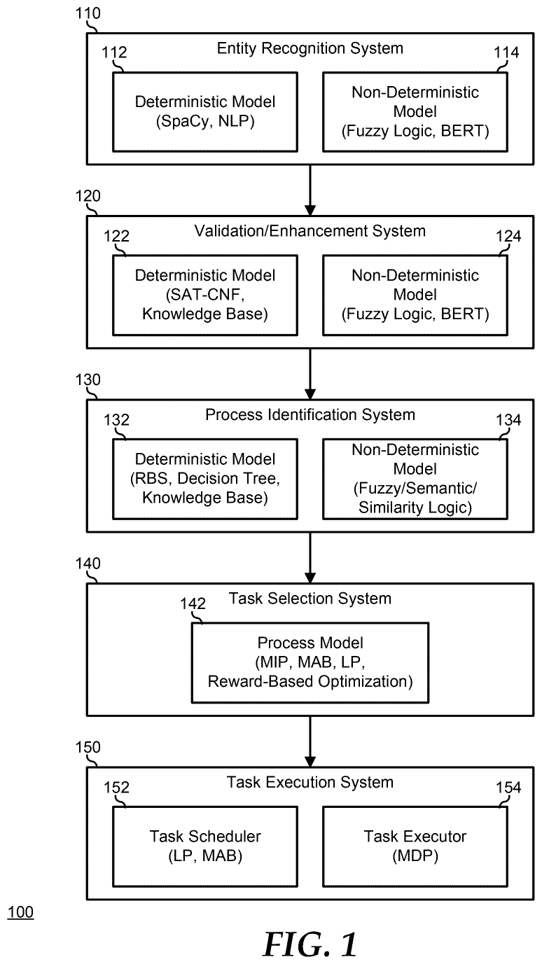

FIG. 1 illustrates an order processing system 100 including an entity recognition system 110, a validation and enhancement system 120, a process identification system 130, a task selection system 140, and a task execution system 150. Order processing system 100 represents a system for fulfilling an order within a processing framework. For example, order processing system 100 may represent a system for the receipt and fulfillment of orders for products or services, for return or replacement of products or services, including warranty processing, for license management, for subscription service management, or other such systems that are configured to receive user input information at a front-end and to process that information to provide a product or service based upon the user input information at a back-end. Order processing system 100 represents one or more information handling system similar to the information handling system described below.

Generally, order processing system 100 may be understood to provide a workflow that fulfills an order from the front-end to the back-end. Such a workflow includes one or more of the following processes: 1) receive input information and recognize specific data entities from the input information, 2) validate the input information and collect additional data entities needed to satisfy the order, 3) identify processes to be utilized in the fulfillment of the order, 4) create additional processes needed to fulfill the order, and 5) execute schedule and execute the processes to fulfill the order based upon the information provided above and generate the outcome of the order. Broadly systems 110, 120, 130, 140, and 150 provide the above workflow for order processing system 100. To perform the workflow systems 110, 120, 130, 140, and 140 may each include a deterministic model element and a non-deterministic model element, as needed or desired. A deterministic model element represents an element that performs its associated task through deterministic processing, such as the recognition and correlation of known forms of data entities and mathematical or flow-based processing unknown but substantially similar data entities into known forms. A non-deterministic model element represents an element that utilizes a predictive models, such as large language models or the like to provide a likelihood of correlation between unknown forms of the data entities and known forms.

Systems 110, 120, 130, 140, and 150 may thus rely first on the deterministic model elements to provide the associated processing, only turning to the non-deterministic model elements when the deterministic model elements are unable to fully recognize and correlate the data elements. The non-deterministic model elements may be configured to provide a probability of recognition and correlation, such as a number value between zero (0) and one (1), a percentage of likelihood of recognition and correlation, such as a number value between zero (0) and 100, or the like. The non-deterministic model elements may further implement a threshold, above which the likelihood of recognition and correlation is deemed to be satisfactory to the continuance of the workflow by ascribing the unknown data elements to the likely known data elements. When the likelihood of recognition and correlation is below the threshold, the particular order may be deemed to be in need of human intervention in order to correlate and approve of the unknown data entities, as needed or desired. Systems 110, 120, 130, 140, and 150 may communicate the results of their internal processes by any communication protocol as needed or desired, such as through an agent communication language (A C L), such as the Foundation for Intelligent Physical A gents (FIPA) ACL, the Knowledge Query and Manipulation Language (KQML), or the like.

Entity recognition system 110 operates to recognize the data entities needed for the follow on processes based upon the input data. The input data may include user inputs related to the process. For example, in a product order processing system, the input data may include the product ordered, including a base model identifier and options, information related to the purchaser such as name, address, email address, or the like, payment information, or other information relevant to the purchase of the product. In this regard, the input data may be received from a web interface application programming interface (API), and may be in any suitable format, such as XML, JSON, natural language, or another format, as needed or desired. Entity recognition system 110 includes deterministic model 112 and non-deterministic model 114. Deterministic model 112 operates to parse the input data to extract known data entities from the input data. For example, deterministic model 112 may recognize known input data information such as dates, names, addresses, email addresses, or the like, and parse such information into associated data entities utilized by the other systems of order processing system 100, as needed or desired. Deterministic model 112 may include a custom trained natural language processing (NLP) models such as a Python spaCy model, a test summarization model, a keyword extraction model, a tokenization model, a Named Entity Recognition (NER) model, or the like.

When deterministic model 112 fails to match the input data to known data entities, non-deterministic model 114 operates to determine probabilities for matches between unknown input data and known data entities. Non-deterministic model 114 may include a fuzzy logic model, a Bidirectional Encoder Representations from Transformers (BERT) model, or the like. When particular input data fails both deterministic model 112 and non-deterministic model (that is, a correlation is below the threshold), than entity recognition system 110 invokes a process that involves a human agent to resolve the failure. It will be understood that deterministic model 112 and non-deterministic model 114 may include self-training to provide quicker, more accurate entity recognition with time.

Validation and enhancement system 120 operates to fill in missing data entities from the known entities provided by entity recognition system 110, and includes deterministic model 122 and non-deterministic model 124. Deterministic model 122 may include a conjunctive normal form satisfiability (SAT-CN F) resolver used in conjunction with a knowledge base, of the like. Non-deterministic model 124 may include a fuzzy logic model, a BERT, or the like, to gather enriched data entities from the trained fuzzy model or a retrieval augmented generation (RAG) model with a vectorized knowledge base, as needed or desired. Deterministic model 122 and non-deterministic model 124 may include self-training and knowledge base updates to provide quicker, more accurate validation and enhancement with time.

Process identification system 130 operates to identify the type of process that the order is directed to, and includes a deterministic model 132 and a non-deterministic model 134. For example, a particular order may be targeted to a product or service purchase order, a product warranty return order, a license purchase or upgrade order, or the like. Deterministic model 132 may include a math rule-based system (RBS) model, a decision tree model, a knowledge base, or the like, to identify the type of process. Non-deterministic model 134 may include a fuzzy logic model, a semantic logic model, a similarity logic model, or the like. Deterministic model 132 and non-deterministic model 134 may include self-training and knowledge base updates to provide quicker, more accurate process identification with time.

Task selection system 140 operates to select the tasks needed to execute the identified process, and to optimize overall process by optimizing between tasks with similar functions and features. A task may be understood to represent a software or hardware module configured to perform a unit of work, and may include an application, a program, a dedicated hardware processor, an API, or another module configured to receive predefined data entities and to provide known output information based on the data entities. Task selection system 140 includes one or more process model. In particular, because the set of tasks within order processing system 100 are known, and for the purposes of any particular order are fixed, task selection system 140 may not be greatly aided in selecting tasks by the inclusion of non-deterministic models. However, the inclusion of non-deterministic models in task selection system 140 are not ruled out in the selection of tasks to complete an order, as needed or desired. Process model 142 may include a mixed integer programming (MIP) model, a multi-armed bandit (MAB) model, a LP model, a reward-based optimization model, or the like. When new task modules are introduced to order processing system 100, the new task modules can be easily integrated by defining the new task modules as modular units.

Finally, task execution system 150 operates to execute the order. Task execution system 150 includes a task scheduler 152 and a task executor 154. Task scheduler 142 may include a LP, a MAB, or the like. Task scheduler 154 may include a Makarov Decision Process (MDP) model to create a template-based process for completion of the order, such as by generating a final Order Structure or Entitlement Details for License Generation.

In a particular embodiment, an order processing system similar to order processing system 100 represents components that work together to produce an outcome. Functions and features as described herein may be incorporated into order processing system 100, and that functions and features as described with respect to order processing system 100 may be incorporated into the presently described order processing system, as needed or desired. A method for order processing by an order processing system may be provided as follows. In particular, let T={t₁, t₂, . . . , tₙ} represent a tokenized input text from which data entities E={E₁, E₂, . . . , Eₖ} are identified, for example, using NER functions. When new entities (E_{new}) are detected, they are tagged and added to the knowledge base K, such that:

K→K_{new} Equation 1.

The identified entities are then mapped to process requirements P, and, based on the knowledge base, a sequence of tasks {T₁, T₂, . . . , Tm} necessary to fulfil the process are determined. Tasks for gathering additional information (e.g., Tᵢ) or assembling the final structure (e.g., Tₘ) are executed in order, with any new tasks added to the system as needed or required. This mathematical sequence of tasks {T₁, T₂, . . . , Tₘ} allows for adaptive learning and modular task execution, ultimately enabling a flexible, template-based approach to process automation.

An entity recognition system similar to entity recognition system 110 identifies key information elements (data entities) such as customer details, product information, or payment methods from structured or unstructured input data. To handle unrecognized entities, fuzzy logic may be used to predict probable matches for unknown data entities, followed by human validation to incorporate the probable data entities into the knowledge base. In a first step, a deterministic model tokenizes an input sequence, where T={t₁, t₂, . . . , tₙ} represents the tokenized input sequence. Each token (t₁, t₂, . . . , tₙ) is passed through NER model, such as SpaCy, to label data entities:

yᵢ=f_{NER}(tᵢ) Equation 2,

where yᵢ∈{Entity Types, Non-Entity}. In this step, the entity recognition system produces a set (E_{known}) of recognized entities with known labels which is already trained, where:

E_{known}={(tᵢ,yᵢ)|yᵢ≠Non-Entity} Equation 3.

For tokens that remain unlabeled (i.e., yᵢ=non-entity), a non-deterministic model employs fuzzy logic to predict possible entity types based on similarity with known entity patterns. Let:

E_{unknown}={ti|yi=non-entity} Equation 4,

represent the set of unrecognized entities. Using a fuzzy matching function:

F(ti,E_{known}) Equation 5,

the non-deterministic model compares each token tᵢ in E_{unknown} to entities in E_{known}, (e.g., from historical data or the knowledge base) yielding a probability score pⱼ for each potential entity type:

pⱼ=F(tᵢ,E_{known},K) Equation 6,

where pⱼ∈[0,1] indexes the entity types within E_{known}. The predicted entity type y′ᵢ is the type with the highest probability:

y′ᵢ=arg(max p) Equation 7.

When y′ᵢ (predicted entity type) meets a confidence threshold τ, it is presented to a human for validation. That is, if:

py′ᵢ≥τ Equation 8,

then validate y′ᵢ with a human-in-the-loop. Approved entities are then added to the knowledge base K to form an updated knowledge base K_{new} so that future instances of this entity can be automatically recognized by the NER model:

K→K_{new}=K∪{(y′ᵢ,tᵢ)}K} Equation 9.

Finally, the complete entity set (E) includes both initially recognized entities E_{known} and validated entities from the fuzzy logic prediction, now represented as:

E=E_{known}∪E_{new}

where E_{new} represents entities that were validated and added through human feedback.

In a next step, a process identification system similar to process identification system 130 operates to identify a process type (such as Order Type, License Type, Subscription Type etc.). A deterministic model precisely identifies the process type, in so far as possible. However if the deterministic model fails to give an outcome, because, for example, a data entity in the tokenized inputs has changed, then the process identification system reverts to similarity and semantic matching to predict the process type or missing entities and get a human in loop to approve and train the model for further process.

The process identification system defines the possible combinations of data entities (E) required for each process type (P={P₁, P₂ . . . Pn}) in a structured way. For example, for each process type Pj, the process identification system can set an exact entity configuration:

Cj={Cj1,Cj2, . . . ,Cjk} Equation 10,

that describes the precise set and structure of data entities (E) required. This configuration acts as a deterministic “signature” for the process type. The process identification system then establishes deterministic mapping rules between the data entities and the process types. These rules may be represented as a set of logic statements or conditions (e.g., If E=Cj, then assign P=Pj). For example, if the data entities (E) include “customer details,” “product model,” and “payment method” in a particular configuration that matches the known structure for an “Order Creation” process, the processes identification system deterministically assigns P=Enterprise Order Type or Software License Entitlement Type. Pseudocode of this activity may be given as:
Let E={E1, E2, . . . , En} be the identified entity set.
For each process type Pj with a configuration Cj, we check: If E=Cj, then P=Pj.
Check E=Cj verifies entity set (E) matches the required entities and structure in Cj.
Each configuration Cj in the knowledge base K is checked deterministically against E.
   This can be represented as a function g(E) that assigns the process type if a rule match is found:

$$P = g ( E ) = \{ \begin{matrix}{P}_{j} & if E = {C}_{j} \\ Fallback & if no {C}_{j} matches E\end{matrix} . \qquad Equation 11$$

If no exact match is found (E≠Cj), the process identification system may use a similarity-based approach as a fallback, where the closest match is selected and validated through a human review process. This ensures there's no ambiguity in the primary, deterministic matching process:
If E≠Cj for all Cj∈K, then perform similarity matching and human review.
   The above steps for process identification may utilize one or more of a math RBS, a decision tree, and a knowledge base lookup, as needed or desired.

In the current embodiment, a final system may incorporate functions and features of task selection system 140 and task execution system 150 as described above. A task manager creates the process (such as order/license/subscription, or the like) based on the data entities (E) and the process types (P) derived. This may include multiple tasks (such as API calls, business logic executions, or the like) needed to be executed in a sequence that ensures efficiency, minimal resource use, and maximum success probability. Such a process creation may include the use of MIP, MAB, LP, and reward-based optimization to model and optimize this process.

In a first step, the system identifies and represents the tasks. Each required task (API call, database query, or business logic operation) in the process can be represented by a variable Ti and structured in a set T={T1, T2, . . . , Tn} where Ti has an associated cost ci, a duration di, a success probability pi, and dependencies on other tasks (such as T3 depends on T1 and T2 being completed). Each task (Ti) can also have an associated reward (ri) if completed successfully, which contributes to the overall objective of maximizing process success.

In a next step, the system formulates task sequencing. An optimization objective is to minimize total cost while achieving the required process structure, using MIP. For example, a Binary Decision Variable (xi) equals one (1) (xi=1) if task Ti is selected, and the Binary Decision Variable (xi equals zero (0) if task Ti is not selected. The objective function can be formulated as:

$$Minimize {\sum }_{i = 1}^{n} {c}_{i} \cdot {x}_{i} , \qquad Equsation 12$$

subject to: ensuring dependencies are met:

xᵢ≤xⱼ, if Tᵢ depends on Tⱼ Equation 13;

ensuring only sequences that achieve the desired outcome (e.g., process creation) are valid:

$${\sum }_{i = 1}^{n} {p}_{i} \cdot {x}_{i} \geq {P}_{min} , \qquad Equation 14$$

where Pₘᵢₙ is the minimum acceptable process success probability; and ensuring that the tasks complete within acceptable time limits:

$${\sum }_{i = 1}^{n} {d}_{i} \cdot {x}_{i} \leq {D}_{max} , \qquad Equation 15$$

where Dₘₐₓ is the maximum allowable time.

The order processing system then proceeds to optimize the tasks. For example, if certain tasks have uncertain outcomes, a MAB approach may be utilized to identify which tasks to select based on past rewards, or if the assigned task fail. In another example, if a task needs to obtain a customer email address, an API may be called. However typically, if the API is down, the whole system will go down. However, recognizing that the email address may also reside in other systems or in previous orders or subscription, a MAB may operate to give more options to complete the task. Thus each arm can be assigned different “ways” to achieve the same task The order processing system assigns the tasks based on the reward function.

More specifically, in a reward-based optimization, each task Ti is treated as an “arm” in the MAB, each task Ti having an associated reward ri based on successful completion. At each decision step, the system evaluates the expected reward E(ri) for each task, balancing exploration (trying less-frequented tasks) and exploitation (choosing high-reward tasks). The MAB reward function at each round t for a task Tᵢ is given by:

$${R}_{i} ( t ) = {r}_{i} + β \cdot \sqrt{\frac{ln t}{{N}_{i}}} , \qquad Equation 16$$

where rᵢ is the reward from previous executions, Nᵢ is the number of times task Ti was executed, and β is a tuning parameter for exploration.

Task scheduling may utilize LP to determine the optimal schedule that minimizes delays and maximizes parallel task execution. Define sᵢ as the start time of task Tᵢ. Then, the objective function to minimize total completion time may be given as:

MinimizeΣi=1 to n[si] Equation 17,

subject to dependency constraints:

si≥sj+dj Equation 18,

if Ti depends on Tj, start time constraints:

s≥0 Equation 19.

Task execution may utilize MDP and a reward function to adaptively select and execute tasks. The execution state may be defined as the current set of completed tasks and system state, an action may be the execution of task Ti based on current state, and the reward can be given upon the successful task completion and minimized cost. A policy π aims to maximize the expected cumulative reward:

$${π}^{*} = arg {max}_{x} 𝔼 [ {\sum }_{t = 0}^{∞} {γ}^{t} R ( {s}_{t} , {a}_{t} ) ] , \qquad Equation 20$$

where γ is a discount factor, and R(sₜ,aₜ) represents the reward for state sₜ and action aₜ.

Returning to FIG. 1, order processing system 100 operates to recognize and extract relevant data entities from diverse input types, including structured, unstructured, and semi-structured data sources, to aid in adaptive order processing orchestration. This recognition leverages NER models combined with deep learning and natural language processing algorithms, allowing seamless data extraction regardless of format to enhance task-specific processing. Order processing system 10 further identifies and sources optimal data points from various internal and external sources using algorithms such as MAB for source selection, dynamic programming for prioritizing retrieval paths, and graph neural networks (GNNs) for mapping relationships between data sources. This process dynamically adapts based on resource availability and operational context, minimizing redundancy and ensuring effective task completion. Finally, order processing system 100 provides a mechanism that ensures immediate workflow recovery by employing reinforcement learning techniques, such as Q-Learning for real-time response refinement, MDP for decision-making under uncertainty, and predictive failure models that leverage historical data to pre-emptively switch data paths. This approach allows order processing system 100 to anticipate failures and instantaneously adapt recovery protocols, optimizing workflow continuity and reducing dependency on static error-handling methods.

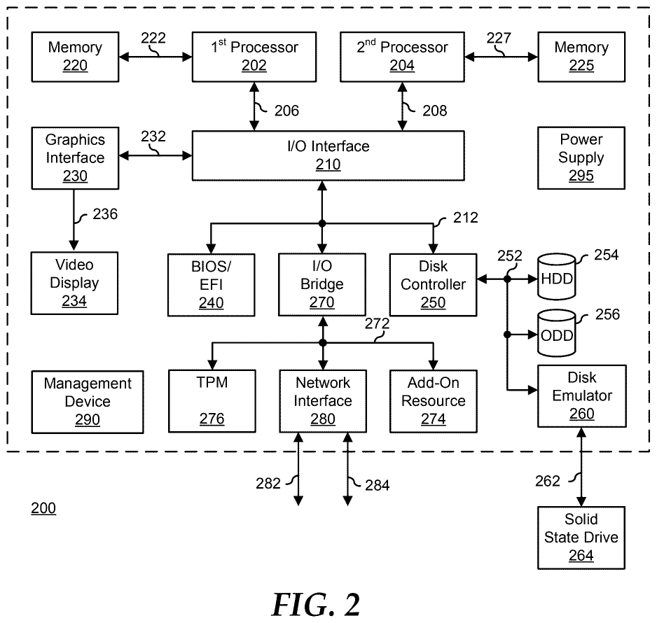

FIG. 2 illustrates a generalized embodiment of an information handling system 200 similar to information handling system 200. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 200 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 200 can include processing resources for executing machine-executable code, such as a central processing unit (CPU), a programmable logic array (PLA), an embedded device such as a System-on-a-Chip (SoC), or other control logic hardware. Information handling system 200 can also include one or more computer-readable medium for storing machine-executable code, such as software or data. Additional components of information handling system 200 can include one or more storage devices that can store machine-executable code, one or more communications ports for communicating with external devices, and various input and output (I/O) devices, such as a keyboard, a mouse, and a video display. Information handling system 200 can also include one or more buses operable to transmit information between the various hardware components.

Information handling system 200 can include devices or modules that embody one or more of the devices or modules described below, and operates to perform one or more of the methods described below. Information handling system 200 includes a processors 202 and 204, an input/output (I/O) interface 210, memories 220 and 225, a graphics interface 230, a basic input and output system/universal extensible firmware interface (BIOS/UEFI) module 240, a disk controller 250, a hard disk drive (HDD) 254, an optical disk drive (ODD) 256, a disk emulator 260 connected to an external solid state drive (SSD) 262, an I/O bridge 270, one or more add-on resources 274, a trusted platform module (TPM) 276, a network interface 280, a management device 290, and a power supply 295. Processors 202 and 204, I/O interface 210, memory 220, graphics interface 230, BIOS/U EFI module 240, disk controller 250, HDD 254, ODD 256, disk emulator 260, SSD 262, I/O bridge 270, add-on resources 274, TPM 276, and network interface 280 operate together to provide a host environment of information handling system 200 that operates to provide the data processing functionality of the information handling system. The host environment operates to execute machine-executable code, including platform BIOS/U EFI code, device firmware, operating system code, applications, programs, and the like, to perform the data processing tasks associated with information handling system 200.

In the host environment, processor 202 is connected to I/O interface 210 via processor interface 206, and processor 204 is connected to the I/O interface via processor interface 208. Memory 220 is connected to processor 202 via a memory interface 222. Memory 225 is connected to processor 204 via a memory interface 227. Graphics interface 230 is connected to I/O interface 210 via a graphics interface 232, and provides a video display output 236 to a video display 234. In a particular embodiment, information handling system 200 includes separate memories that are dedicated to each of processors 202 and 204 via separate memory interfaces. An example of memories 220 and 230 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 240, disk controller 250, and I/O bridge 270 are connected to I/O interface 210 via an I/O channel 212. An example of I/O channel 212 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 210 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. B IOS/U EFI module 240 includes BIOS/U EFI code operable to detect resources within information handling system 200, to provide drivers for the resources, initialize the resources, and access the resources. BIOS/UEFI module 240 includes code that operates to detect resources within information handling system 200, to provide drivers for the resources, to initialize the resources, and to access the resources.

Disk controller 250 includes a disk interface 252 that connects the disk controller to HDD 254, to ODD 256, and to disk emulator 260. An example of disk interface 252 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 260 permits SSD 264 to be connected to information handling system 200 via an external interface 262. An example of external interface 262 includes a USB interface, an IEEE 1394 (Firewire) interface, a proprietary interface, or a combination thereof. Alternatively, solid-state drive 264 can be disposed within information handling system 200.

I/O bridge 270 includes a peripheral interface 272 that connects the I/O bridge to add-on resource 274, to TPM 276, and to network interface 280. Peripheral interface 272 can be the same type of interface as I/O channel 212, or can be a different type of interface. A s such, I/O bridge 270 extends the capacity of I/O channel 212 where peripheral interface 272 and the I/O channel are of the same type, and the I/O bridge translates information from a format suitable to the I/O channel to a format suitable to the peripheral channel 272 where they are of a different type. Add-on resource 274 can include a data storage system, an additional graphics interface, a network interface card (NIC), a sound/video processing card, another add-on resource, or a combination thereof. Add-on resource 274 can be on a main circuit board, on separate circuit board or add-in card disposed within information handling system 200, a device that is external to the information handling system, or a combination thereof.

Network interface 280 represents a NIC disposed within information handling system 200, on a main circuit board of the information handling system, integrated onto another component such as I/O interface 210, in another suitable location, or a combination thereof. Network interface device 280 includes network channels 282 and 284 that provide interfaces to devices that are external to information handling system 200. In a particular embodiment, network channels 282 and 284 are of a different type than peripheral channel 272 and network interface 280 translates information from a format suitable to the peripheral channel to a format suitable to external devices. An example of network channels 282 and 284 includes InfiniBand channels, Fibre Channel channels, Gigabit Ethernet channels, proprietary channel architectures, or a combination thereof. Network channels 282 and 284 can be connected to external network resources (not illustrated). The network resource can include another information handling system, a data storage system, another network, a grid management system, another suitable resource, or a combination thereof.

Management device 290 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 200. In particular, management device 290 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 200, such as system cooling fans and power supplies. Management device 290 can include a network connection to an external management system, and the management device can communicate with the management system to report status information for information handling system 200, to receive BIOS/UEFI or system firmware updates, or to perform other task for managing and controlling the operation of information handling system 200. Management device 290 can operate off of a separate power plane from the components of the host environment so that the management device receives power to manage information handling system 200 where the information handling system is otherwise shut down. A n example of management device 290 include a commercially available BMC product or other device that operates in accordance with an Intelligent Platform Management Initiative (IPMI) specification, a Web Services Management (WSM an) interface, a Redfish Application Programming Interface (API), another Distributed Management Task Force (DMTF), or other management standard, and can include an Integrated Dell Remote Access Controller (iDRAC), an Embedded Controller (EC), or the like. Management device 290 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed:

1. An information handling system, comprising:
a memory device to store code; and
a processor to execute code to:
receive a plurality of input information items associated with a process request;
evaluate the input information items with a first deterministic model to associate a first portion of the input information items with known data entities and to classify a second portion of the input information items exclusive of the first portion of the input information items as unknown input information items;
evaluate the second portion of the input information items with a first non-deterministic model to associate the second portion of the input information items with the known data entities;
evaluate the known data entities with a second deterministic model to determine whether a process type of the process request can be identified by the second deterministic model, and when the process type can be identified, identify the process type;
when the process type cannot be identified by the second deterministic model, evaluate the known data entities with a second non-deterministic model to identify the process type;
select one of a plurality of tasks associated with the process type; and
execute the task to fulfill the process request.

2. The information handling system of claim 1, wherein the first deterministic model includes at a natural language processing (NLP) model.

3. The information handling system of claim 2, wherein the NLP model includes one of a Python spaCy model, a test summarization model, a keyword extraction model, a tokenization model, and a Named Entity Recognition (NER) model.

4. The information handling system of claim 1, wherein the first non-deterministic model includes one of a fuzzy logic model and a Bidirectional Encoder Representations from Transformers (BERT) model.

5. The information handling system of claim 1, wherein the second deterministic model includes one of a math rule-based system (RBS) model, a decision tree model, and a knowledge base.

6. The information handling system of claim 1, wherein the second non-deterministic model includes one of a fuzzy logic model, a semantic logic model, and a similarity logic model.

7. The information handling system of claim 1, wherein the code is further to evaluate the known entities with a third deterministic model to determine whether the known entities can be validated with the third deterministic model.

8. The information handling system of claim 7, wherein the code is further to when the known entities can be validated with the third deterministic model, validate the known entities with the third deterministic model.

9. The information handling system of claim 8, wherein the code is further to when the known entities cannot be validated with the third deterministic model, validate the known entities with a third non-deterministic model.

10. The information handling system of claim 9, wherein the third deterministic model includes one of a conjunctive normal form satisfiability (SAT-CNF) resolver and a knowledge base, and the third non-deterministic model includes one of a fuzzy logic model and a Bidirectional Encoder Representations from Transformers (BERT) model.

11. A method, comprising:
receiving, by an information handling system, a plurality of input information items associated with a process request;
evaluating the input information items with a first deterministic model to associate a first portion of the input information items with known data entities and to classify a second portion of the input information items exclusive of the first portion of the input information items as unknown input information items;
evaluating the second portion of the input information items with a first non-deterministic model to associate the second portion of the input information items with the known data entities;
evaluating the known data entities with a second deterministic model to determine whether a process type of the process request can be identified by the second deterministic model, and when the process type can be identified, identify the process type;
when the process type cannot be identified by the second deterministic model, evaluating the known data entities with a second non-deterministic model to identify the process type;
selecting one of a plurality of tasks associated with the process type; and
executing the task to fulfill the process request.

12. The method of claim 11, wherein the first deterministic model includes a natural language processing (NLP) model.

13. The method of claim 12, wherein the NLP model includes one of a Python spaCy model, a test summarization model, a keyword extraction model, a tokenization model, and a Named Entity Recognition (NER) model.

14. The method of claim 11, wherein the first non-deterministic model includes one of a fuzzy logic model and a Bidirectional Encoder Representations from Transformers (BERT) model.

15. The method of claim 11, wherein the second deterministic model includes one of a math rule-based system (RBS) model, a decision tree model, and a knowledge base.

16. The method of claim 11, wherein the second non-deterministic model includes one of a fuzzy logic model, a semantic logic model, and a similarity logic model.

17. The method of claim 11, further comprising evaluating the known entities with a third deterministic model to determine whether the known entities can be validated with the third deterministic model.

18. The method of claim 17, further comprising when the known entities can be validated with the third deterministic model, validating the known entities with the third deterministic model.

19. The method of claim 18, further comprising when the known entities cannot be validated with the third deterministic model, validating the known entities with a third non-deterministic model.

20. An information handling system, comprising:
a memory device to store code; and
a processor to execute code to:
receive a plurality of input information items associated with a process request;
evaluate the input information items with a first deterministic model to associate a first portion of the input information items with known data entities and to classify a second portion of the input information items exclusive of the first portion of the input information items as unknown input information items;
evaluate the second portion of the input information items with a first non-deterministic model to associate the second portion of the input information items with the known data entities;
evaluate the known data entities with a second deterministic model to determine whether a process type of the process request can be identified by the second deterministic model, and when the process type can be identified, identify the process type;
when the process type cannot be identified by the second deterministic model, evaluate the known data entities with a second non-deterministic model to identify the process type;
select a first one of a plurality of tasks associated with the process type; and
execute the task to fulfill the process request;
wherein the first deterministic model includes at a natural language processing (NLP) model including a Python spaCy model, a test summarization model, a keyword extraction model, a tokenization model, and a Named Entity Recognition (NER) model;
wherein the first non-deterministic model includes a first fuzzy logic model and a first Bidirectional Encoder Representations from Transformers (BERT) model;
wherein the second deterministic model includes a math rule-based system (RBS) model, a decision tree model, and a knowledge base; and
wherein the second non-deterministic model includes a second fuzzy logic model, a semantic logic model, and a similarity logic model.
